(19) United States
(12) Patent Application Publication
(10) Pub. No.: US 2002/0078046 A1
(43) Pub. Date: Jun. 20, 2002

(54) Method of component-based system development

(76) Inventors: Tamer Uluakar, Plainsboro, NJ (US); J. Timothy Hale, Dallas, TX (US); Andrew G. Labrot JR., West Hartford, CT (US)

Correspondence Address: JENNIFER H. HAMMOND, SONNENSCHEN NATH & ROSENTHAL, P.O. BOX 061080, WACKER DRIVE STATION SEARS TOWER, CHICAGO, IL, 60606-1080, US

(21) Appl. No.: 09/732,663

(22) Filed: Dec. 8, 2000

Related U.S. Application Data
(60) Provisional application No. 60/170,055, filed on Dec. 10, 1999.

(51) Int. Cl. G06F 17/30

(52) U.S. Cl. 707/8

(57) ABSTRACT

A method for component-based systems development includes one or more components with a preferably common database for storing business data. By using several steps or phases, the method includes identifying business processes and information of principal importance to the business, classifying the information, and utilizing component-based systems development to produce a deliverable set of software applications. The business data can be stored in the components and can be accessed and processed via an interactive electronic terminal such as a computer and application software. Legacy systems can be incorporated by the method such that existing data can be utilized for new applications.

### CROSS-REFERENCE TO RELATED APPLICATION

Continuation-in-Part of Provisional Patent Application Serial No. 60/170,055, filed Dec. 10, 1999.

### BACKGROUND OF THE INVENTION

Systems development relates to the use of computer software and hardware to maintain, access and process business data. Known methods of systems development are based on the idea that a business should store all its data in a single, integrated database to avoid redundancy in inputting, maintaining and accessing the data and associated problems. Although using a single database reduces redundancy, it becomes nearly impossible to change the database without having significant, and often adverse, impacts on each program and application that accesses the data.

Also, under traditional approaches, before implementing new data or changing a database for a particular project, an analyst is forced to search beyond a project's scope to find all the data that should be included before implementing or changing data.

Component-based development (“CBD”) addresses these problems by sharing data not databases. CBD is not a technology. Rather, it is a delivery solution based on the idea of assembling pre-tested components into applications. The concept behind CBD is one of isolation: isolate one process from the inner workings of another process. In achieving this goal, components communicate with each other via well-defined and published interfaces. The processes internal to the component are encapsulated, or hidden, from calling processes.

Components are independently deliverable sets of software services. Components “own” their own data and allow access to it only through their services. This approach avoids redundancy while limiting the impact of changing a database to only one component.

Components have two principal aspects. One aspect is a description or modeling of the behavior and execution of a business process. A second aspect is the implementation or physical design of the storage of data and actual software executables to accomplish the business process.

The art contains several methods approaching component-based systems development. Information engineering has been used to build data modeling and provide business event analysis. Object-oriented analysis and design concepts have also been used and place emphasis on encapsulating various aspects of business functionality within separate components. This results in reduced complexity, increased responsiveness to business change, and faster optimization and delivery of applications. However, this approach can be improved to meet modem requirements.

Any approach to applications analysis needs to be able to accommodate future business requirements, the details of which often are not clear. Under the prior approaches, an analyst tries to clarify future requirements by asking “what-if” questions. This tends to make analysis a lengthy, complex process. This tends to be a time-consuming and inefficient process. Therefore there is a need to quickly solve present business needs while maintaining the flexibility to accommodate timely and cost-effective changes as future requirements arise and become understood.

Many large companies, such as insurance companies, have substantial investments in mainframe systems which are inherently rigid and not easily adapted to changes required by internal or external developments. Due to the limitations of their existing legacy systems, such companies have traditionally been forced to develop a stand-alone “stovepipe” system for each new product offering. However, stovepipe systems may weaken a company's ability to compete because they are:

costly, with significant up-front development and ongoing maintenance expenses rendering certain small, but profitable, niche lines of business uneconomical to pursue;

time-consuming to construct, hindering timely responses to market opportunities; and

a barrier to the sharing of information across products, thereby eliminating a source of potentially valuable market intelligence and requiring multiple system inquiries by salesmen and support personnel seeking to sell or manage products across product lines.

Still further, a problem faced by some companies, such as property and casualty insurers, is their inability to respond to evolving system requirements due to changes in business practices and regulatory conditions. These changes manifest themselves via needs to capture additional data and change workflow associated with the support of new products, market segments and distribution channels. Therefore, there is a need to provide a means and method that permit a company to efficiently respond to evolving system requirements caused by changes in business practices and/or regulatory conditions.

One of the areas requiring most of the maintenance by some company's IT departments is the interfaces between the many policy administration systems and external interfaces to those systems. Systems such as document processing, rating engines for insurers, statistical analysis, financial reporting and agency interfacing all have significant maintenance requirements associated with ensuring their consistency. Heretofore, prior systems have not been able to efficiently meet these needs.

Therefore, there is a need for a means and method for developing a system that can efficiently meet such needs.

Still further, many companies are often unable to enter niche lines of business because they cannot earn an adequate return on the investment required to develop an IT system to support the line. Therefore, there is a need for a method of developing an IT system that will be cost effective to permit a company to enter a niche line of business.

In some industries, such as the insurance industry, business processes for different sections of the business can vary significantly. These differences are based on the products supported, distribution channels accessed, market segment selected for the products and the operational support required. In the past, this has been a difficult issue for in-house development staffs as well as vendors. Therefore, there is a need for a method whereby variations in business processes can be quickly and efficiently accommodated.

Still further, using prior systems, system changes to enforce business rules surrounding what information is asked for by a user, what selections are valid for a user to choose from and under what business conditions information should be requested have been handled within the domain of the user's information technology departments. Business users are often forced to wait several months to have even minor changes made to a screen. Therefore, there is a need for a method that allows the creation and maintenance of business rules to reside within the domain of the business thereby allowing for rule changes to be implemented in a more timely manner.

### TECHNICAL FIELD OF THE INVENTION

The present invention relates to the general art of computer-based system design, and to the particular field of component-based systems development. Specifically, the invention relates to providing systems to optimize the handling of business data and providing business solutions.

### SUMMARY OF THE INVENTION

These, and other, objects are achieved by the means and method embodying the present invention which are a marriage between component-based development and business analysis. Unlike prior methods, the present invention does not require complex modeling rules and a myriad of different diagrams to achieve optimized solutions. It does not force the analyst to think in terms of discrete technical object solutions, but rather frees the analyst to focus on broader solutions to business problems. Thus, the present invention improves on prior methods in that only the data required by the project at hand need be discovered and defined. The method of the present invention uses systems, information and the like in modular form to define the basic structure in a manner that permits use of existing information, etc. but also allows addition of new information, systems, etc. as well as replacement of existing data, information, etc.

By building components around presently-existing business procedures, the means and method of the present invention is able to develop practical business solutions with an innate responsiveness to change. Incremental system development is provided which allows results to be realized from the beginning, a benefit not found in over-burdened, monolithic systems development.

One important result of the present invention is the degree to which components can be generic or reusable. Experience has shown that in the rush to implement CBD systems, service providers often fail to gain a full understanding of the business applications at hand. By trying to create fully generic components, providers can over-burden a system with overlapping services that never quite meet a client's needs, especially if those needs are unique to that particular client.

By focusing on providing specific business solutions that can be generalized gradually, the methodology of the present invention provides a balanced, incremental approach that never loses sight of the “big picture.” The methodology of the present invention permits an entire framework of components to be developed in support of a business process. The establishment of a component framework helps maintain a balance between the pieces and the whole, thereby ensuring that each component actually contributes to the overall business functionality.

As components are carved out for existing resources and modified to enhance functionality, they are fed directly back into the business. This incremental approach increases shared software modules while cutting down on solution-driven time. The methodology of the present invention provides solutions that are immediately applicable while still being open to future development. Thus, both greater flexibility and greater potential for re-use are realized in a functional, component-driven application designed to meet the overall business needs. Also, this allows the user a great deal of input in the analysis and design of systems which results in a stronger, better and more comprehensive match with the user's needs.

With flexibility built in at a functional level, the methodology of the present invention generates applications that are consistently easier to maintain and significantly easier to change at a later date than prior methodologies.

More specifically, the method of the present invention generally comprises five phases. A first phase, initiation, is used for providing an overview of a project. Business processes are outlined and information and rules relating to the applications are gathered and established. The project scope is established. A component framework is established. The next phase is visualization, the objective of which is to describe the proposed applications and its components to convey what the application will look like and how it will behave. Facets are prototyped. Components are developed further. Legacy systems are identified. Specification, another phase, fully details all aspects of the facets, the behavior of component services and the hubs' logic. The next phase is design which translates the specifications into designs which can be built and implemented as applications. Finally, an implementation phase involves writing or generating the code for each application, testing and finally installing the application on hardware.

The methodology of the present invention is designed to be completely technology-independent. The invention allows the flexibility for system architecture to cross platform and operating system boundaries. Equally important in providing this flexibility is the fact that the method embodying the present invention is completely supported by CBD '96 Standards, and is completely complementary, though not limited to, the enterprise level tools developed by Sterling Software. The method of the present invention allows developers the freedom to choose the correct set of tools to deliver a desired solution. In some cases, some of the tools are already in house thereby helping IT organizations to avoid the costly mistakes and wasted time associated with large technology learning curves and new development tools. The method of the present invention also allows companies to rise above the technology wars waged weekly in the press and remain focused on providing timely business solutions to pressing business needs.

The method of the present invention reduces time to market cycle, has a rapid deployment of “business critical” solutions through component re-use and the use of legacy systems and is responsive to business process change. The method delivers business solutions versus IT solutions.

The method of the present invention also has significant cost containment and uses an organization's previous investment in legacy systems and technologies while providing a stable application execution environment.

The method of the present invention allows organizations to rise above technology wars and remain focused on providing timely business solutions to pressing business needs. As technologies mature, and make business sense to employ, the method of the present invention provides a framework for the integration of these technologies into the enterprise.

The method of the present invention is an event-based system that helps users to participate more fully in the system development process, thereby resulting in higher quality systems that better fit user needs.

Using the method of the present invention, user interfaces can be created using a variety of tools (for one set of users, a standard GUI interface might be appropriate; whereas, for another set of users, a spreadsheet interface may be appropriate).

The method of the present invention allows IT to proceed quickly without having to integrate everything all at once. The method allows IT to create components that are needed for the scoped application. Services that aren't needed until later are developed in later projects deferring future issues to future releases without loss of overall integration. Over time, component re-use significantly reduces cycle time for bringing software applications into production.

Furthermore, incremental development of components in the present method minimizes risk of project failure.

The method of the present invention leverages existing IT skill sets such as system development know-how, or the like, to rapidly deliver new business solutions. It also simplifies application development and enhancement processes.

In view of the foregoing, the IT staff is able to invest in their futures with transferable skills, and the use of the latest technologies allows staff to keep pace with the IT industry.

The method embodying the present invention includes six phases that guide the user through a successful, repeatable process for developing and implementing software solutions, including large-scale projects. The schematic shown in FIG. 11 provides an overview comparing the phases of the method embodying the present invention to a standard development process.

Throughout the phases shown for the inventive method, the method employs a standardized development lexicon that categorizes each element of an IT system based on one of the following four terms: facet, hub, component and component service. These terms are fully defined elsewhere in this disclosure.

The method of the present invention has several significant advantages over prior development methodologies. These advantages include:

Superior capturing of business rules. The present method includes a rigorous, systematic approach to capturing business logic which allows an analyst to model businesses accurately and efficiently. In addition, the general nature of the visualization phase, coupled with the method's use of business lexicon, enables users to avoid “analysis paralysis.”

Harvesting of legacy IT assets. The method of the present invention harvests a client's legacy IT assets, thereby preserving a substantial portion of the client's prior information technology investment of time, money and intellectual capital. The method extracts legacy system functionality by “wrapping” the existing legacy code and capitalizing on current advanced technologies by integrating wrapped legacy functionality with new applications.

Focus on incremental delivery of solutions. Rather than attempting to implement a complete re-use initiative immediately, the method of the present invention focuses on providing incremental application solutions by harvesting components gradually. Users identify components to be carved out of existing resources and these are re-designed to enhance functionality. These components are then re-integrated into the business, increasing the use of shared software modules and reducing solution-delivery time. This method allows incremental results to be realized early during an IT project, without the system down-time which can result from more monolithic development approaches.

Tightly integrated, loosely coupled systems. Applications developed using the present method are characterized by a well-developed ability to “communicate” with each other by sharing data or generic functionality. This is highly conducive to the development of shared user interfaces and web-enabled systems for e-business. Furthermore, by properly designing and building components to be independent of one another, the present method allows an organization to add, remove or modify elements of its system without disrupting the remaining, unrelated, elements of the system.

Technology independence. The method of the present invention is designed to be completely independent of any one technology, thereby allowing the flexibility for system architecture to cross language, operating system and database boundaries. This provides developers with the freedom to choose the optimal set of tools for solution delivery, and to use those tools which a customer already employs, thereby avoiding expensive and time-consuming acquisition of new technologies and retraining of employees.

The method of the present invention also allows customers to respond to the opportunities and related challenges posed by migration to e-business channels.

The method of the present invention helps customers overcome the problems associated with stovepipe systems by preserving the viable elements of legacy systems and integrating those element, along with new components and applications. The resultant systems are integrated and scalable and allow customers to modify their systems easily as their business requirements change.

While the insurance industry will be mentioned as a specific target of the method described herein, it is noted that no limitation is intended. The insurance industry is being used as an example for the best mode requirements of the statutes.

The method of the present invention facilitates accommodation of evolving system requirements by permitting business personnel to make a system change and have the change reflected in the presentation of information to users, storage of information in databases and transmission of the new information to the appropriate external systems, all without programmer intervention. This permits a large company to quickly respond to evolving system requirements due to changes in business practices and regulatory conditions.

Furthermore, the method of the present invention enables rapid consolidation of product offerings and related systems.

The method of the present invention has been designed to reduce the burden associated with maintaining interfaces between policy administration systems and external interfaces to those systems. New information can be captured and automatically sent to the interfaced systems requiring that information with minimal programmer intervention.

Specifically, with regard to the insurance industry, the method of the present invention permits all transactions that can occur within a policy's life cycle, including quote, endorsements, cancellation, reinstatement, renewal, and out of sequence endorsement to be supported by the components of the system.

The method of the present invention also permits a company to enter a niche line of business because the method utilizes components and their corresponding services in a manner that possess the majority of the logic that must be developed to create a system capable of supporting a new product or line of business. Use of the components reduces the cost and effort required to modify an existing system or deliver a new system, making entry into smaller, niche lines of business a viable profit opportunity.

The method of the present invention overcomes the problems associated with varying business processes by allowing a user to tailor the manner in which the components are called to support a new business process flow. Workflow is transferable from one application to another as services supporting each application may be the same, but may be called in a different order. This allows business personnel to respond more quickly to changes in their business as they are no longer dependent upon IT personnel to complete system modifications to facilitate changes in work flow.

The components and applications developed according to the present invention are designed for maximum flexibility, rapid response and integration of different business units and technologies. Using the methodology of the present invention, loosely coupled and highly integrated applications are created that allow customers to respond to business change while leveraging viable elements of their legacy operating systems.

One aspect of the method embodying the present invention is the provision of three basic elements: facet, hub and components, and a clear separation of what is private to one application and what is intended for sharing among multiple applications. The facet and the hub are private to an application. The user interacts with the application through the facet, which often consists of screens, windows and reports. The hub provides services to the facet by requesting and packaging services from business components. The hub also controls transaction integrity. The business components can be shared among multiple applications. They provide services that apply business rules and also access and change data.

Another feature of the method of the present invention is the use of complementary technologies that harvest legacy systems' assets. Through comprehensive approach to managing the increasingly complex application execution environment, the method of the present invention provides a roadmap showing how to easily and seamlessly access service from throughout an enterprise to address changing business needs. By using the method of the present invention, a straightforward process to revitalize legacy system functionality is realized. The existing resources can be leveraged using the method of the present invention.

Instead of rewriting and replacing code for still-viable systems that may simply need a new user interface or enhancement of functionality, the approach provided by the method of the present invention provides an incremental and immediate solution using existing IT assets. Over time, pieces of the legacy system's functionality can be replaced with newer business components. With the framework provided by the method of the present invention in place, it is easy to reroute old functionality to new components. An advantage of the present invention is the flexibility it provides in delivering timely solutions to immediate business needs.

### OBJECTS AND ADVANTAGES OF THE INVENTION

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a block diagram illustrating the principal steps of the method of component-based system development which embodies the present invention.

FIG. 2 is a block diagram illustrating the relationship between applications and component software services employed by the applications within the method of the present invention.

FIG. 3 is a block diagram illustrating steps of an exemplary business process of a business for which systems development using the method of the present invention may be employed.

FIG. 4 is a block diagram illustrating steps of another exemplary business process.

FIG. 5 is a block diagram illustrating relationships between anchor terms, as developed using the method of the present invention.

FIG. 6 illustrates a sample component framework.

FIG. 7 is an overview of a component-based application architecture embodying the present invention.

FIG. 8 illustrates a software release broken into slices.

FIG. 9 illustrates incremental project delivery using application slices.

FIG. 10 illustrates use of COOL:GEN™ models in projects.

FIG. 11 illustrates a comparison between a prior art method of systems development and the method of the present invention in which the method of the present invention requires only data from the project at hand.

FIG. 12 is a diagram of an overview of a basic system embodying the teaching of the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Other objects, features and advantages of the invention will become apparent from a consideration of the following detailed description and the accompanying drawings.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

At the outset, it will be helpful to define several terms which will be used herein. Unless otherwise indicated, the defined terms should be given the following meanings in connection with the method:

“Anchor Terms” are things which are of prime importance to the business. Anchor terms are used to verify project scope and to drive detail gathering as the project begins. There are relatively few anchor terms within a business area. The early focus on anchor terms helps remove ambiguity and clarify communication between business users and developers. Identification of anchor terms provides the first cut of candidate components.

A “project” is a specific plan or design to which the method is applied to achieve a desired result.

An “application” is computer software which provides a user interface or access, and workflow processing. In the present invention, applications are made up of three basic elements: facets, hubs and components. ApplicationSoftware provides the user interface and workflow processing. A component-based application contains no business rule processing or persistent-data storage of its own. Instead, it calls on the services of one or more components to perform business rule and data access functions.

An “application slice” is a section of an application which is being developed at one time. The method of the present invention supports and encourages the incremental development of applications. An application slice is a collection of facet and hub modules and supporting component services which are being developed together. Often, these facet modules and supporting hub modules are closely related and have some significant dependencies on one another. Application slices exist from the visualization through the build phases of the method of the present invention. All application slices for one project are merged into a project release during the delivery phase.

An “anchor terms diagram” is a graphical representation of anchor terms. It helps show aggregates and the symmetry between terms leading to better understanding of how components are related.

A “facet” represents the surface of an application or its total interface to the world in support of a business process. It is the collection of windows, screens, reports, etc. through which the outside world interacts with the application. It is designed for one business process. A facet contains only the interaction logic required to facilitate information exchange between the outside world and the rest of the application. It contains no business rules; it simply passes any “work” that needs to be done to its exclusive “hub” as a request and waits for a response. Each application has one facet which it owns in its entirety—facets are not shared across applications. Facets contain no business logic, but rather control workflow and user interface (UI) navigation.

A “facet request” is packaging of user events into bundles of related requests which are forwarded to an application hub for processing. For example, two events, “user updates customer address” and “user requests customer credit approval” may have been identified. At facet design time, one window might be designed to handle the updating of customer address and the credit authorization. A facet request bundles together the two events into one request so that the hub can respond appropriately. The facet request facilitates the separation of facet prototyping and even analysis, and provides a mechanism for fitting together the results of each at design time.

A “remote hub” is a portion of a hub module which consumes component services in cases where hub functionality is split across multiple platforms.

A “facet module” is an individual screen, window, or report which is part of the overall application facet.

A “hub” serves its facet by acting on requests. Hubs “know” which services of which business components to call on for each request. Otherwise, hubs contain only enough logic to handle transaction integrity and certain types of exception handling. The hub is typically a mainframe computer or server.

A “local hub” is the portion of a hub that communicates directly with the facet in cases where hub functionality is split across multiple platforms.

A “component” is an independently deliverable set of software services. The component can be thought of as a container that is comprised of one or more specific services. The services typically share all or part of a common interface (input and output variables), and a common persistent data store/data base.

One of the functions/behaviors offered by a component is “service.” Each service provides a public specification which is its contract with all potential consumers. This specification describes exactly what will occur given a specific pre-condition. Each service also contains the internal (private) specifications which govern exactly how the service will perform its functions. The component's “service” allows access to the component. Each service performs a well-defined function that usually consists of some manipulation of information housed by the component. The service contains specifications describing how the component will process data. In physical terms, the service contains one or more computer programs (e.g. COOL:GEN action blocks™) which validate input data, apply business rules, access persistent data, and provide a response to the service consumer.

A “service interface” is the part of the public specification of a service which describes the input, output and error parameters that are used when consuming the service. The input and output parameters are composed of some or all of the data elements from the component's class diagram.

A “hub module” is an individual executable which provides hub services to a facet module. Hub modules receive facet requests and call the appropriate component services to respond to those requests. Hub modules rarely contain business logic, but rather, control transactional integrity. In other words, hub modules act as commit units, determining when and if the work of the individual services has completed in such a way that the facet request has been satisfied.

Hub functionality may be contained in one program on one platform, or it may be split across multiple programs and platforms as needed (for example, in cases where the facet resides on a different platform than one or more of the consumed components).

“Hub service” is a hub-level response to one facet request. Hub services are identified in the Specification phase before the actual hub services are assigned to a specific hub module in the Design phase.

An “implementation model” is a COOL:GEN™ (or other development tool) model which contains the private (internal) logic and persistent storage for component services. The implementation model is used by component builders to develop the programs and data storage to support the service specifications. There is one implementation model for each component.

A “component interface” is the set of public services which a component provides for consumption by applications and the services of other components. The interface includes the composite of all input/output parameters for the component's services as well as the service constraints. A class diagram is used to document the data structure portion of the component interface.

A “neighbor component” is an analysis term which describes components that are related to one or more of the components under development. Neighbor components provide services to the components under development, or to the application that supports the primary business process.

A “business process” is a series of actions or operations by a business directed at a particular result. This is a high level, on-going activity of the business such as customer acquisition or the like. The business process is the focus of any particular application. A business process is supported by one logical application with its associated facet.

A “business event” is an event which is triggered by an actor or the passing of time to which a business must respond. Business events are used to understand exactly which user events will be making demands on the application. Examples of business events include “customer requests product quote” or “customer communicates a change of address.”

A “component framework” is a diagram which shows the “big picture” of all components being developed in support of a business process. The diagram is organized by business process, and then business objects within each process. It is used to communicate the relationship of components under development. It also differentiates neighboring processes and their components from the components of the primary business process. A sample component framework is shown in FIG. 6.

“Event analysis” focuses on the identification and understanding of business situations which must be planned for in the development of an application. It is founded on the realization that all activities included in man-made systems are planned responses to anticipated situations (events). Event analysis is an effective technique for understanding business requirements since events are easy to identify, familiar to a business user and can be defined independently of system behavior. The method of the present invention recognizes two levels of events. Business events are external events in that they occur from outside the control of the business and are usually initiated by an actor who is not part of the business (such as a customer). User events, on the other hand, are internal events initiated by actors who are using the computer application to respond to a business event.

A “class” is a collection of objects which share a common set of services or behavior and use the same data structure.

A “class diagram” is a graphical representation of one component's classes including their relationships, attributes, and (sometimes) services. The class diagram contains the sum of all data elements which may be used by one or more of a component's services interfaces. A class diagram is used as a communications tool between the analyst and business representative. It is also used to guide the designer of the component's persistent data storage after specification. One form of the invention uses the component modeling tool of COOL:GEN™ for this purpose.

A “neighbor component” is an analysis term which describes components that are related to one or more of the components under development. Neighbor components provide services to the components under development, or to the application which supports the primary business process.

“Persistent storage” is the physical storage of data using a database or file management system. Persistent storage is accessed directly by component services only, and never by the application.

A “Pre/Post Condition pair” is part of the specification for each component service. Each service is described by one or more pre/post condition pair. Each pair describes the response of the service (post-condition) given a specific input (pre-condition). Along with the specification of input and output data elements, pre/post condition pairs make up the bulk of the service specification “contract.”

A “referential class” is a class which is owned by one component but is also included in the Class Diagram of another component to provide context. When included as a referential class, only the identifying attribute(s) are shown.

A service (component service) is one of the functions/behaviors offered by a component. Each service provides a public specification which is its contact with all potential customers. This specification describes exactly what will occur given a specific situation. Each service contains the internal (private) specifications which govern exactly how the service will perform its functions.

CBD is an acronym for component-based development. It is a software delivery solution based on the idea of assembling pre-tested components into applications.

CBD 96 is a set of industry standards for CBD and is published by the Component Advisory Board and Sterling Software. It gives guidance on component object naming, component specification, service implementation, structure, and common interface parameters that allow components to communicate with applications and other components.

A “specification document” is the formal agreement used in a CBD project. It describes in full detail the input and output parameters of each component service, as well as all possible behaviors (pre and post condition pairs). Once this document is completed for a component and its services, both the application and component developers can begin their work in parallel. The specification document contains one Class Diagram for the entire component and specification section for each service. The service section includes a description of the service, its formal name, module name, input and output parameters and pre- and post- condition pairs.

A “specification moder” is a development tool such as COOL:GEN™ which contains the public specification of one component and its services. The specification model contains a class diagram, and one action block for each service. The action block for each service contains the input and export views for the service in addition to notes for each of the pre/post-condition pairs, and the statement such as “external” (COOL: GEN™).

A “transient entity type” is a COOL:GEN™ data-modeling object which represent data elements which will not be implemented as persistent (stored) data. This is used to build class diagrams.

A “use case” is a structured description of a scenario in which an event initiator (actor) will interact with the planned application. It is an analysis technique used to identify business events for which there must be a planned response from the application. Use cases are typically not exhaustive, but rather are analyzed for only the most important or complex situations.

A “user” is an entity (person or organization) which interacts directly with the application facet.

A “user event” is a distinct interaction between a user and the application which requires a planned response from the application. User events are analyzed to help understand exactly what events a user may invoke from a facet and which services will be required to respond to the facet event. Examples of user events include requests to “list all customers of type X,” or “change customer status to inactive,” or the like. The user events inputs include business documents and interviews, an anchor terms diagram, a component framework, a project scope document and a facet prototype.

II. Overview

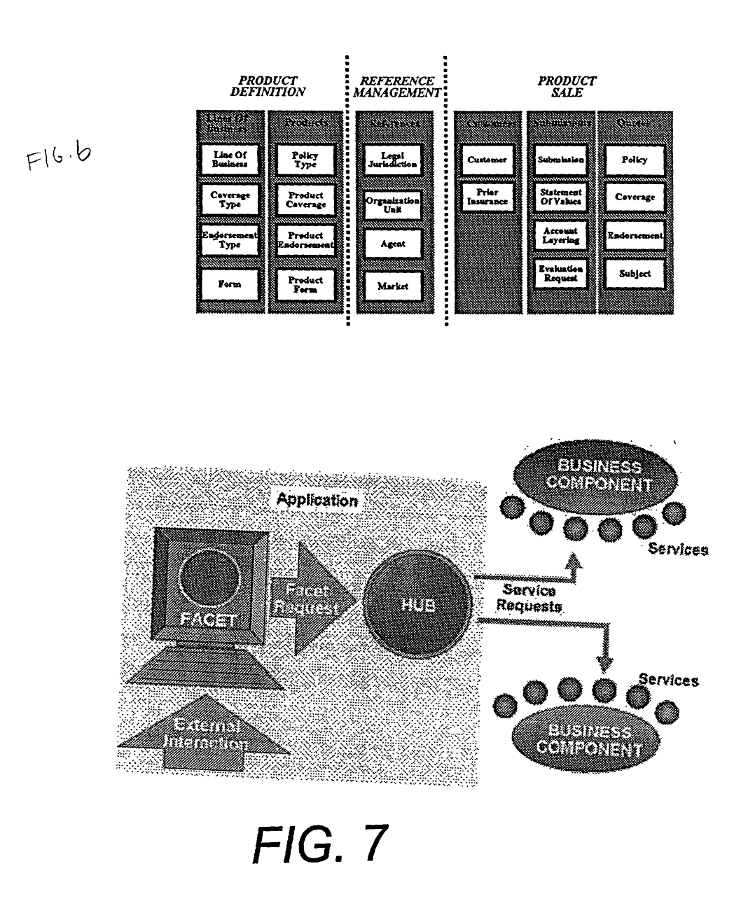

As discussed above, and as illustrated in FIG. 7, the method of the present invention is not intended to replace an entire application in one manifestation. Rather, it is a balanced approach to develop needed business functionality through the reuse of existing components, the creation of new components and the tapping of legacy systems for any functionality still applicable to the business. By using a very focused process of carving out pieces of a legacy system, users can quickly take advantage of new technology (such as the Internet) by wrapping old technology. This method of leveraging legacy systems will be very beneficial to delivering effective business solutions within reduced time frames. Using the approach of the present invention, an overall system can be built using existing data and then modified as necessary to meet future needs and requirements. Services can be modified, deleted or added as required to meet future needs and requirements. A diagram further presenting an overview of a basic system developed according to the present invention is shown in FIG. 12 in which only data required by the project at hand need be discovered and defined. Various services are indicated in FIG. 12 to show that services can be added, deleted or modified as necessary to meet changing requirements. Some of the services shown in FIG. 12 can be legacy as well.

FIG. 12 shows a diagram with an overview of the basic system of the present invention labeled with terminology used in this method. In broad terms, the six phases of the method of the present invention can be separated into two parts. The initiation, visualization and specification phases comprise the content portion of the method, where the functionality, or content, of an IT system is developed based on rigorous business analysis. The technology part of the process, including the design, build and delivery phases, and entails designing and building the technological architecture of a system in order to make it work from a technology perspective.

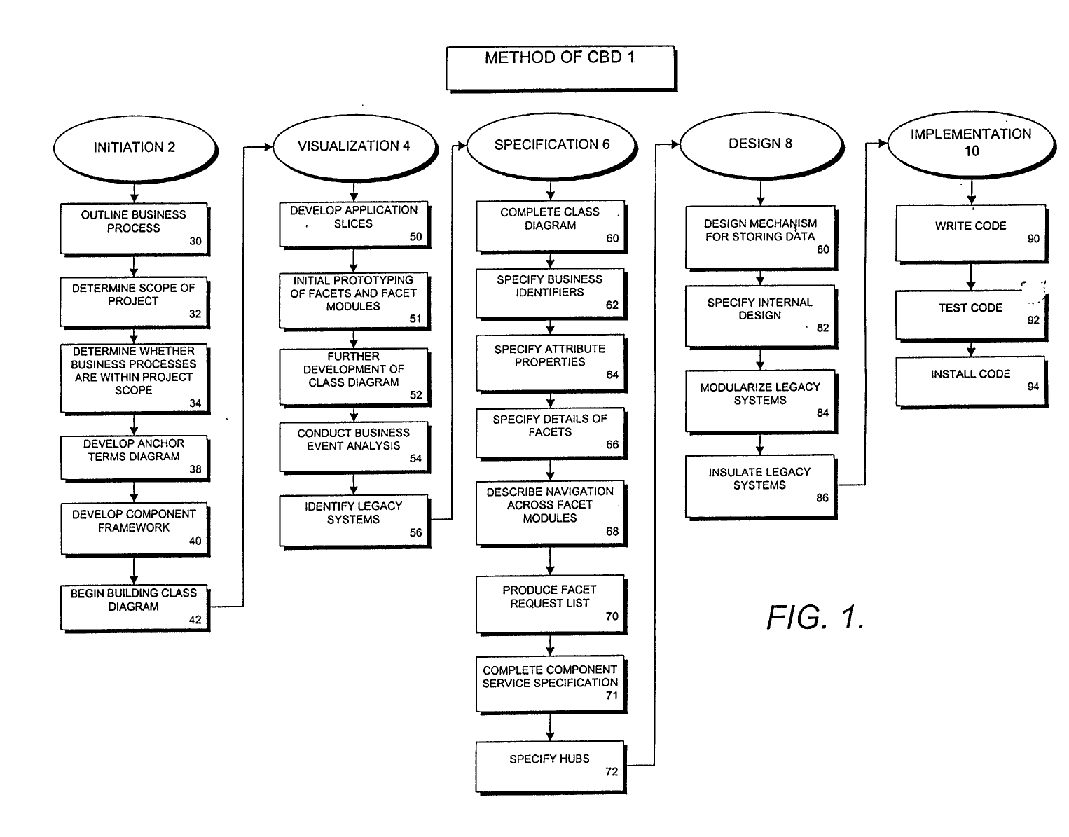

Referring to FIG. 1, the reference numeral 1 generally refers to a method of component-based systems development embodying the present invention. The method 1 generally comprises five general steps or phases: initiation 2, visualization 4, specification 6, design 8 and implementation 10, which will be dealt with individually below. The method 1 can be applied to any project. As discussed more below, it should be noted that the method 1 is not necessarily linear. That is, different portions of the project may be in different phases at the same time.

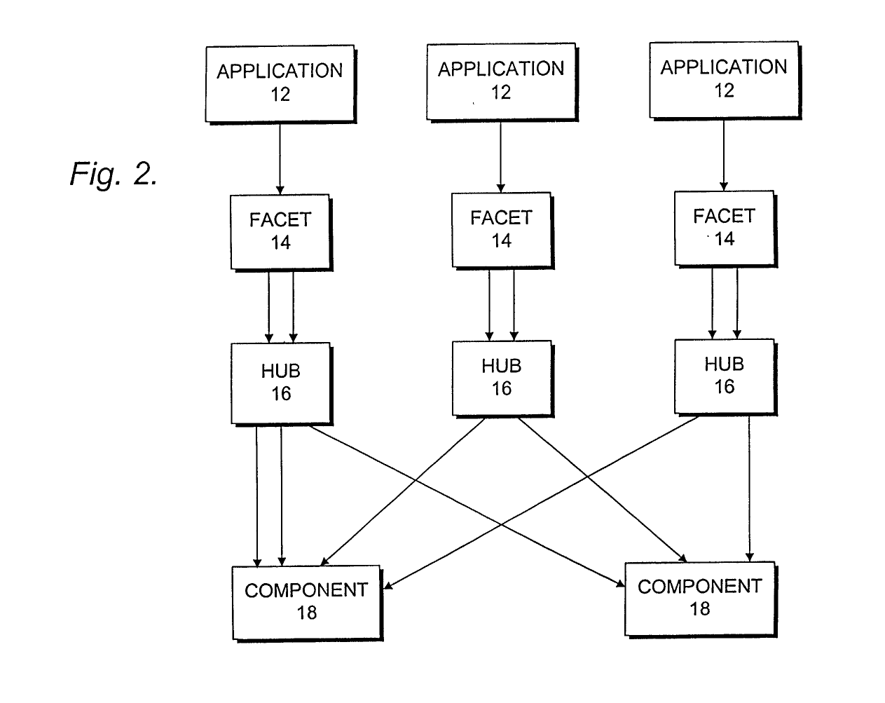

Referring to FIG. 2, the end result of the method 1 is one or more applications 12. As indicated previously, each application 12 is best described as computer software which provides a user interface and workflow processing. The applications 12 can receive inputs, process information, and produce outputs.

At its core, each application 12 is comprised of three different elements: facets 14, hubs 16 and components 18. As stated previously, the facets 14 allow interaction between the outside world (e.g. users) and the application 12. Examples of the facets 14 include computer windows and computer output screens. The hubs 16 serve the facets 14 by acting on their requests. The hubs 16 are typically mainframe computers. The components 18 are independently deliverable sets of software services. Under the method 1, the facets 14, the hubs 16 and the components 18 interact with one another in unique manners. Each facet 14 is associated with a respective hub 16. However, the hubs 16 can be associated with or interact with numerous components 18. That is, while a given facet 14 and a given hub 16 are each “owned” by a given application 12, a component 18 can be shared by many applications 12.

For illustration purposes, much of this specification will discuss the method 1 as it relates to component-based systems development for use in the insurance industry. However, the method 1 can be applied to any virtually any business or industry. The present invention is built upon identifying, defining and optimizing underlying business processes such that one or more application 12 can be developed.

III. Initiation 2

The focus of the initiation phase is the “big picture” of a system. The goal of this phase is to create a conceptual architecture of the system, i.e., an understanding of the basic functionality required of the system. This is accomplished by a business analysis via a number of steps, including project scoping, component identification and class diagraming.

One element of the method is to focus on application slices, which are also identified during the initiation phase. An application slice is a section of an application, and includes a collection of facet and hub modules and supporting component services, that are developed together. A slice must be clearly separable and identifiable from a business perspective and must be able to be built independently from a technology perspective. Throughout the balance of the inventive methodology, from the visualization phase through the delivery phase, work is accomplished by slice. While a slice may contain multiple components, each component is contained within a single slice to avoid having more than one “slice team” responsible for developing a single component. While each slice is completed through the repetition of the final five phases, the methodology is designed to facilitate the parallel development of multiple slices currently and encourages the incremental development of applications.

The initiation phase establishes the “big picture” that governs all other phases. Primary topics are project scoping, component identification and class diagraming.

Referring to FIG. 1, one step of the method 1 is initiation 2. As indicated at block 30, the first step in initiation 2 is outlining the business process(es) of principal interest to the project, and identifying information and rules that are needed to support the business process(es). Outlining the business process(es) is important to clarify the scope of the project. The outlines are not intended for detailed documentation of the business process(es). Rather, they are used to identify major segments of each business process. Each business process is representative of an end result.

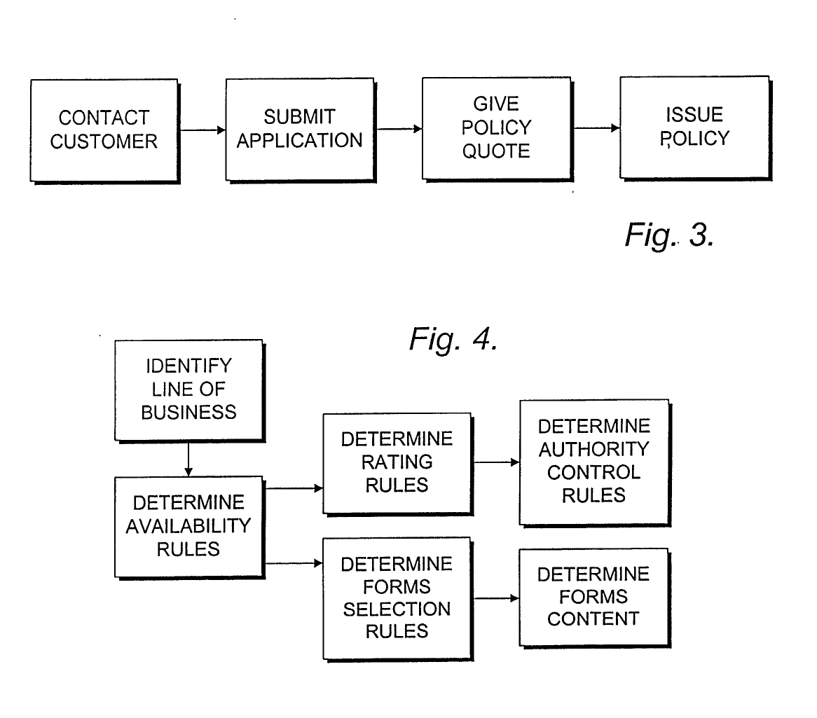

For example, business processes for an insurance company might include product definition, product sale, claims processing, reinsurance treaties, marketing, and agency management. Referring to FIG. 3, the business process outline for “product sale” may include the following: contacting a customer, submitting an application for insurance, a quotation by the insurer, and the issuance of a policy.

Similarly, referring to FIG. 4, the business process outline for “product definition” may include: identifying the insured's line of business, determining availability of insurance rules, determining insurance rating rules, determine authority control rules, determining insurance form selection rules, and determining insurance form content.

As indicated at block 32, the project's scope 14 should also be defined during initiation 2. A project scope document includes several inputs including component framework, business process outlines, application slice list, project schedule, project resource plan and reuse targets. Returning to the insurance industry, an example of the project scope for the insurance industry is “building a product sale application.”

As indicated at block 34, each business process is examined to determine whether it is included in the project's scope. Frequently, several business processes will be within the project's scope. The segments that own information or rules required by the project are considered in the project's scope.

As indicated at block 38, the next step in initiation 2 is developing an anchor term diagram. Anchor terms represent conceptual or tangible things of central importance to a business. However, not all important things qualify as anchor terms. Anchor terms are determined by first examining the information and rules associated with each business process. Next, it is necessary to determine what the information describes, or how the rules relate to the process. Inputs to an anchor terms diagram include existing anchor terms diagrams as well as business documents and interviews.

Building an anchor term diagram can be better understood by considering the following example. As discussed earlier, in the insurance industry the “product sale” may include the customer obtaining a quote from the insurer. An examination of the quote will find that it includes information such as a policy number, an effective date and a name insured. All of this information describes or relates to a policy. Therefore, the term “policy” emerges as a possible anchor term.

As another example, it was previously determined that the term “product definition” may include the availability rules. Upon further examination, it is determined that the availability rules include specifying the geographic locations where a type of policy may be sold. The rules are about a policy type, and thus the term “policy type” emerges as another possible anchor term.

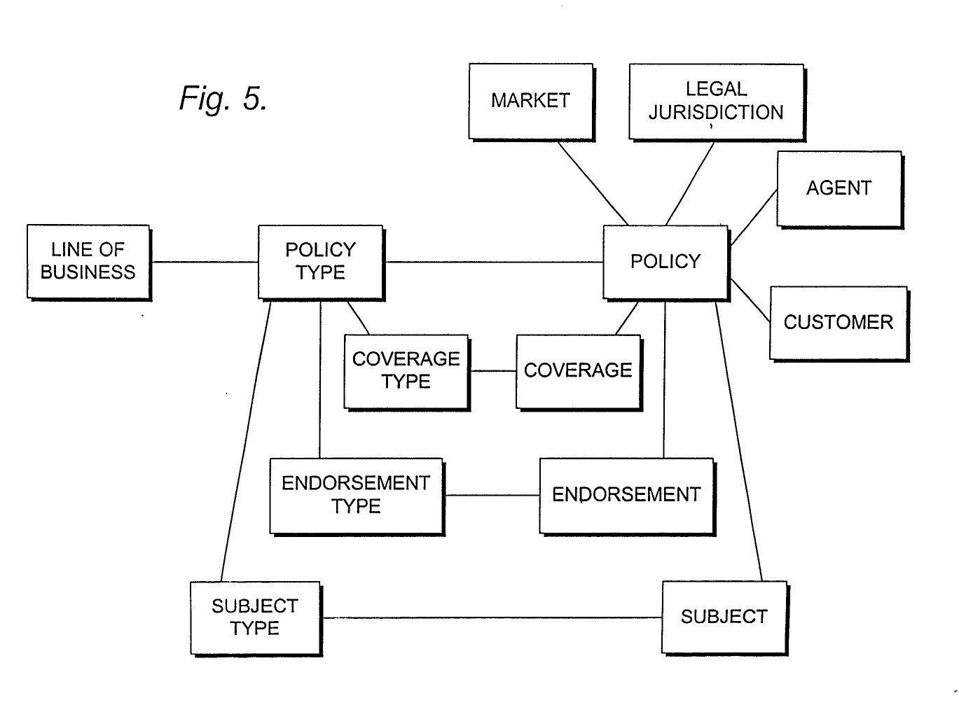

Referring to FIG. 5, a anchor term diagram is shown which graphically depicts the how “policy” and “policy type” are chosen as anchor terms. Note that the left half of FIG. 5 contains terms from the “product definition” business process; while the right half contains terms from the “product sale” business process. It is important to look for associations between pairs of anchor terms and to depict them graphically on the anchor terms diagram. This is depicted by relative placements of the associated terms and by connecting lines between them.

Finally, all the anchor term candidates are compared to one another, and the relatively less important candidates are eliminated. The total number of anchor terms normally should not exceed twenty so that the anchor term diagram will remain relatively uncluttered.

As indicated at block 40, after agreement has been reached within the project on the anchor terms and their definitions, the component framework containing the components can begin to be developed. The component framework includes all the components 18 that are utilized by the application 12. The anchor terms diagram serves as a foundation for the component framework. All anchor terms become component candidates, or “potential” components.

Additional component candidates can also be identified. Unlike anchor terms, additional component candidates do not have to be limited to things of central importance to the business. Rather, the primary criterion for accepting additional component candidates is the quantity of information and rules associated with the component candidate. For example, returning to the insurance industry, a “submission” of a claim may not be of central importance to the business, but due to the quantity of submissions and the rules governing submission, it nonetheless may become a component candidate.

The component candidates must be evaluated to determine which ones will become components 18. The following objectives serve as guides for this evaluation: the size and complexity of each component 18 should be kept manageable; unrelated subject matters should be separated; subject matter that may change drastically in the future should be separated; functionalities that may be reused by different aspects of the business should be separated; subject matter for which components may be available or may become available in the future should be separated.

The component(s) 18 should also be briefly defined to help organize and plan the overall method 1. During the initiation 2 phase, this definition consists of a few sentences of rudimentary description followed by a class diagram (discussed more below). For example, returning to the insurance industry, assume that “policy participant” is selected as a component 18. A description of “policy participant” is “people and organizations that are associated with each policy.”Examples of policy participant are “additional insured,” “lien holder,” and “condominium association.” The policy participant component allows the adding and removing or participants to policies. It also allows viewing existing participants and updating their information.

Note that in preparing the component framework, a distinction should be made between principal and neighbor components. All components other than those supporting the primary business purpose are referred to as neighbor components. This distinction between those components used to maintain or make changes to information (e.g. principal component 18) and those used to retrieve or read information (e.g. neighbor components) may become important in later phases of the method 1.

Inputs into the component framework include anchor terms diagram, existing component framework, business documents and interviews and existing applications documentation.

As indicated at block 42, the class diagram should also be built in initiation 2. The class diagram is used to describe the structure of the components 18 in terms of data and behavior. The primary purpose of the class diagram is to fully describe the data which will be used as inputs and/or outputs for component services and for storage in databases. Thus, class diagrams are used to fully document the data that are used during the interaction between the component 18 and the consumer of its services. Inputs into a class diagram include class diagram (preliminary), facet prototype, existing applications documentation, business documents and interviews and component service visualization.

The class diagram can be created by following several steps. The first step is to identify the central object or class for each component 18. This identified class becomes the central class in the class diagram. For example, in the insurance industry an “insurance policy” could be a class. The next step is to describe the identified class by assigning attributes thereof so that its purpose is clear and it can be distinguished from other classes. For example, “number,” “effective date,” and “expiration date” are all attributes of the class for “policy.” The third step is to identify and describe referential class(es). The referential classes describe data which belong to other components 18, but provide context to the class in the current component 18. For example, “policy type” may be a referential class of the class for “policy.” The referential class(es) must be identified and described as belonging to one of the other classes. Finally, relationships or interaction between central classes and referential classes must be described, and relationships or interaction among referential classes should also be described. For example, the class for “policy” has a relationship to the class for “policy type.” This relationship can be used to document the type of policy being offered (e.g. home, auto, life).

IV. Visualization 4

As the development effort proceeds, it progresses through increasing levels of detail. In the visualization phase, the focus shifts from the “big picture” to the slices identified in the initiation phase. The visualization phase is the first step where the user describes the application and its components with the description prepared in just enough detail to convey what the application will look like and how it will behave. Visualization encourages the development process because it ensures that both the developer and the customer have a high-level understanding of, and are in agreement on, the application before significant time and resources are invested to specify the application in detail. This intermediate stage in the analysis process, before detailed specification, helps to avoid the “analysis paralysis” which often results in prior art methods.

During visualization, business events and user events are completed. A business event is an event triggered by an initiator or the passing of time to which the business must respond. Business events are used to understand which user events will be making demands on the application. Examples of a business event are responding to a request to generate a policy quote for an insurer or to communicate a change of address.

A user event is a distinct interaction between a user and the application which requires a planned response from the application. User events are analyzed to help understand what events a user must invoke from a facet and which services will be required to respond to the facet event. Examples of user events are inputting requests to provide quotes, list customers of a specified type, change of customer status, or the like.

The objective of the visualization 4 phase is to describe the proposed application 12 and its component(s) 18, quickly and in just enough detail to convey what the application 12 will look like and how it will behave.

To this end, as indicated at block 50, application slices must be developed. Each application slice contains a part of the application 12 that can be separately visualized, specified, and developed. Application slices collectively constitute the entire deliverable for each software release. Whenever possible, the application slices are chosen to contain a single component 18. Returning again to insurance, a “policy participant” application slice might be chosen to include the “policy,” “policy type,” and “line of business” components 18.

Inputs into the application slice list include component framework and business documents and interviews.

Also, during visualization 4, as indicated at block 51 an initial depiction or prototyping of the facets 14 and facet modules is completed. The main purpose of such prototyping is to identify and design the content of the facets 14 and to explain their interaction with users and external systems.

Facet prototyping requires a good understanding of the desired interaction between the application 12 and its environment. Facet prototyping should include the informational content of the facet module. For example, in insurance there may be a facet module (e.g. a window) for “policy participant” and an associated field for “policy participant role.” The facet prototype should also show how a user will interact with each facet module and how the facet modules will interact with one another to produce a desired result.

Also during visualization 4, as indicated at block 52 the class diagram is developed to a greater level of detail. For example, additional attributes may be determined and added to the classes. Consider the “policy” class for example. Attributes of that class include “date of issue” or “expiration date” may be added. Also, any additional classes may be identified. There may be additional classes identifiable within the scope of the component(s) 18 which are less prominent, or subordinate to the central classes.

As indicated at block 54, business event analysis can also be used during visualization 4 in connection with prototyping facets and building components 18. For example, business event analysis may be used to identify business situations and define required responses to the situations. In visualization 4, business event analysis may also be used to identify component services. For example, a service of the component 18 for “create sale” may be defined as the “recording of the particulars of a sale along with the payments if the payment is received.”

As indicated at block 56, another step in visualization 4 is the initial identification of legacy systems. A legacy system is a preexisting system containing information that can be utilized by the application(s) 12. The legacy systems can be organized into interfaces that correspond to components 18. The use of legacy systems within the method 1 will be discussed more below.

The visualization phase outlines the requirements for an application from the user's point of view. Primary topics are Business Event Analysis, Service Identification, Class Diagram refinements, fact prototyping and identifying candidate services for reuse.

V. Specification 6

During specification, a “contract” is developed which will be used to develop both component services and the application which will be using those services. During this phase, all aspects of the facet that are observable to users are finalized along with the behavior of the component services involved and the hub logic. In order to facilitate successful CBD, the class diagram must be frozen at the end of the specification phase. Furthermore, as this is the final phase before the design and build phases begin, the emphasis switches to: (1) researching and documenting the details, (2) filing in the holes, (3) resolving outstanding data issues, and (4) confirming the class modeling results with the facet and component service requirements. It is during the specification phase that Instance IDs are created. These fifteen digit numeric attributes facilitate the idea of “plug-and-play” component application assuming among the inventive method's components as well as other components that are compliant with CBD96.

In the specification phase, the detailed requirements for an application slice are defined. Primary topics are full specification of services including data and behavior, application of CBD 96 standards, mapping of facets to services through user events and hubs and legacy wrapping.

Specification 6 fully details all aspects of facets 14 that are observable to users, the behavior of the component 18 services involved, and the hub 16 logic.

As indicated at block 60, in specification 6 the class diagram which was developed earlier to an “outline” level is completed. This means that all classes including attributes and relationships between the classes must be identified and fully detailed. Inputs into a detailed class diagram include class diagram (refined) and facet module specification.

In general, the same techniques used during initiation 2 and visualization 4 are employed. The emphasis switches from that of identification to that of researching and documenting the details, filling in the “holes,” resolving outstanding data issues and confirming the classes.

By the beginning of the specification 6 phase, it is expected that the vast majority of the classes will have already been identified and described. A few “minor” classes may surface during specification, and some adjustments to existing descriptions may be necessary.

As indicated at block 62, business identifiers for all classes must also be specified. A business identifier is a collection of one or more attributes and/or relationships that, in combination, allow the business to distinguish between occurrences of the class. An example is a policy number which is used to distinguish a policy from other policies.

Also, as indicated at block 64, during specification 6 the specification of attribute properties of the classes must be fully completed. For example, a complete business description defining the purpose and scope of the class attribute should be completed. Also, the domain, length, and permitted values of the attributes of the class should be specified.

As indicated at block 66, during specification 6 the facets 14 are described in much greater detail. For example, the following should be specified: a description of the use of the facet 14, a representation of the facet 14 (e.g. a GUI object), whether a facet 14 attribute is an input or an output, whether a facet 14 attribute is optional, whether a facet 14 attribute is disabled for certain events, default values, permitted values, formatting and editing patterns, and sorting order. It is noted that a facet prototype is developed by analyzing workflow and designing user-interface content. Inputs into developing a facet prototype include business documents and interviews, anchor terms diagram, component framework, project scope document and facet prototype.

As indicated at block 68, navigation across the facet modules is also fully described including a detailed description of what needs to occur when each facet module is initiated or closed. For example, the opening of a window may enable certain push buttons and populate certain list boxes.

The specification phase also includes a deliverable of facet module specification which includes tasks of completing a user-interface diagram; identifying facet requests; assigning user events to a facet and requests; and includes inputs of facet prototype and user events.

As indicated at block 70, facet 14 specification is completed by producing a facet 14 request list. The facet 14 request list contains all the facet 14 requests along with their corresponding business events. In addition, each facet 14 request is documented to specify how and when it is triggered, the corresponding attributes sent to and received from its respective hub 16, and the actions that need to be performed before or after each facet 14 request.

As indicated at block 71, another step of specification 6 is completing a component service specification. Components 18 typically have several services which are related to accessing and manipulating the information contained within the component 18. The component service specification is a tool to communicate requirements to develop the component 18. Inputs into a component service visualization include user events and class diagram (refined).

Furthermore, the visualization phase also includes a reuse visualization deliverable that includes tasks of identifying existing IT assets for reuse and assessing existing IT assents for reuse; with the inputs including: user events; component service visualization and class diagram (refined).

In preparing the component service specification, inputs and outputs should be specified. The list of inputs will include the minimum number of identifying data elements that the service would need to retrieve the required outputs. The list of outputs typically includes all data fields pertaining to classes of interest plus identifying information that enables a consumer to use other services of the component 18. Pre-conditions and post-conditions, and reason/return codes should also be determined. The behavior of each service is described in terms of pre-condition and post-condition pairs. Each pair consists of a specific, detailed pre-condition and a corresponding detailed post-condition. For example, consider a service named “delete customer.” One possible precondition for that service is that a valid customer identifier is currently in a database. A post-condition for such a pre-condition is that the specified customer will be removed from the database and specific return/reason codes will be returned to a calling program. Another possible pre-condition is that an invalid customer number is provided. A post-condition for such a pre-condition is that no database action is performed, and return/reason codes will be returned to the calling program. Further inputs into the component service specification involve component service visualization, facet module specification and class diagram (detailed).

Depending on the complexity of the service, it may be necessary to offer further description thereof For example, if there are optional inputs, the conditions under which they are optional should be specified.

As indicated at block 72, another step in specification 6 is specifying the hubs 16. Each facet 14 has an exclusive hub 16 that responds to its request. Hubs 16 consume the required component services to respond to each facet 14 request. All the logic required to respond to a facet 14 request is contained in a hub service. The hub service is generally specified just like the component service with the component 18 as the “consumer” of the hub 16.

The internal logic of the hub service must also be specified. The internal logic can be structured using business event analysis. Each business event needs to have a separate section within the hub service. For each business event, the hub 16 may call on one or more of its services to process the request. As with component services, pre-conditions and post-conditions and reason/return codes should be specified.

Inputs into the hub service specification include facet module specification, user events and component service specification.

Furthermore, the specification phase also includes a deliverable of reuse service specification which includes tasks of specifying services for reuse and existing IT assents; and includes inputs of component service visualization and facet module specification.

VI Design 8

In the design phase, the emphasis shifts to the technical terms used in the method of the present invention. The design phase includes tasks which translate the application and component specifications into designs, which can then be built and implemented for the target runtime platforms. In the design phase, most of the activities involve designing the structure and logic of the software modules which will implement the facet, hub and component services.

The hardware and software platforms involved strongly influence the design phase, and during this phase, the designer makes sure he or she thoroughly understands the customer's technical architecture. The technical architecture includes items such as: (1) the facet or presentation layer, which includes Internet/Web, GUI/Client Server and Block-Mode; (2) hub platforms, which include client/server, mainframe and other devices used to communicate between the facets and the components; (3) service layers, which are the devices such as servers and mainframes that operate the services that comprise the components; (4) the communications platform and software; and (5) the database platform and software. By the design phase the customer's technical architecture is fully developed.

The design is heavily influenced by the application infrastructure in the method of the present invention. While the technical infrastructure governs the hardware and software platforms on which the application will run, the application infrastructure guides the look and feel of the applications as well as the style used to design the internal portions of the facets, hubs and components. Specific topics addressed include: (1) the facet style within the technical platform (e.g., command-driven versus menu-driven for block-mode); (2) facet design standards such as colors, menu items and font; (3) database standards; (4) coding and naming standards; (5) the error handling scheme; and (6) the cross-component referential integrity approach.

Design 8 is strongly influenced by technical architecture (e.g. hardware and software platform(s) upon which the application 12 will execute). Therefore, it is important that the technical architecture be understood before design 8 tasks begin. The technical architecture includes such items as the facet 14 platforms (e.g. Internet, server, etc.), the hub 16 platforms (e.g. server, mainframe), the service layer (e.g. server, mainframe), and the database platforms and software.

Design 8 is also heavily influenced by application infrastructure. The application infrastructure guides the “look and feel” of the application 12 as well as the style used to design the internals of the components 18, the facets 14, and the hubs 16. For example, the following should be considered during design 8: facet 14 style (e.g. command driven or menu driven, etc.), facet 14 design standards (e.g. colors, menu items, font, etc.), stored data (e.g. database) standards, coding and naming standards, error handling scheme, cross-component referential integrity approach. Design 8 may be altered depending upon the variables discussed above.

Design 8 will be now discussed using COOL:GENT™ software. As indicated previously, the method 1 can be adapted to any suitable software. A mechanism for storing data must be designed for any component 18 that provides services which directly access stored data. The classes in the class diagram serve as a starting point for stored data (e.g. database) design. While COOL:GEN™ software has been mentioned, those skilled in the art will understand from the teaching of this disclosure that other software can be used, including COOL:PLEX™, COOL:2E™, as well as other COOL software by Sterling Software and Microsoft as well as middleware provided by IBM and the like without departing from the scope of this disclosure. Other development tools from Microsoft as well as from IBM can also be used.

As indicated at block 80, a database must be designed. In most COOL:GEN™ projects, persistent data storage is supplied by a relational database. The following steps are involved in designing the database using COOL:Gen™. First, a component implementation subject area is created. Classes, attributes and relationships are then copied into the implementation subject area.

Next, data is normalized and/or denormalized. Then, additional persistent data storage attributes are added as required. Persistent data model is transformed into physical data design. Finally, database standards are applied (e.g. naming, performance enhancements, etc.).

As indicated at block 82, internal design of the application 12 must also be considered. The internal design of the application 12 is best described as a series of software modules each with a specific function. A public interface module is the only module that can be directly consumed by another service or application 12. The data exposed to the service or application 12 is in transient views thus the public interface module contains no logic. A service coordinator module directs the sequence in which other modules and services are functionally involved. Among other things, the service coordinator module ensures mandatory inputs are present, and translates transient views to persistent views, and vice versa. A rule engine module performs all necessary business edits. A data module accesses persistent data storage. An external action block module is used to access legacy systems, as discussed below.

As indicated at block 84, the use of legacy systems should be further considered during design 8. First, existing systems need to be analyzed to determine if there is sufficient data that can be accessed by the components 18 and the systems. The existing systems should be modularized (e.g. by separating business logic from data access logic) such that their data is callable.

As indicated at block 86, once the legacy system(s) are modularized, further insulation of the systems is required. Further insulation enables the legacy system(s) to be later replaced without having to change all systems that access the legacy system. In order to achieve insulation, a “wrapper” component is used to encapsulate each legacy system. The wrapper is responsible for providing access to legacy system(s) and for presenting a consistent interface to calling applications. The wrapper insulates calling programs from any and all changes to the called systems. For example, if a legacy system were replaced by a package, the only changes required would be to the internal logic and mappings of the wrapper services which access the existing application, as opposed to all calling processes and systems. The wrapper can be accessed by the external action block module.

In designing wrapper services the following guidelines should be followed. Presentation logic, business logic, and data access logic should be kept separate. Interfaces should be designed to allow for growth, to meet process requirements for external systems, and to meet data requirements for calling programs.

VII. Implementation 10

The build phase involved writing or generating the code for each software module as well as unit testing that code. During this phase, automated construction tools are used from Sterling as well as several construction tools from Microsoft to generate the executable code that comprises its software components and applications. In order to integrate the components and applications built with customer legacy assets, the method uses MQSeries from IBM. Use of automated tools provides substantial time and cost savings as well as significant flexibility to respond to future changes compared to prior programming. In addition, by using Sterling's COOL:GEN™, the ability is provided to build solutions that will function in virtually any operating environment, database and language and by using IBM's MQSeries, these solutions are able to be integrated with virtually any legacy IT asset. The generation and installation of the persistent storage mechanism are also completed in the build phase. Persistent storage is physical storage of data using a database or other file management system. Persistent storage is accessed directly only by component services, never by the application.

It is during the build phase that “wrappers” are constructed. Wrappers allow customers to leverage existing IT assets by preserving and providing access to viable elements of existing systems. The wrappers encapsulate legacy and/or package functionality and allow integration of those assets with the new components and applications assembled or built.

As indicated at blocks 90, 92 and 94, implementation 10 involves writing or generating the code for each software module, testing and finally installing the code as run-time executables. In general, implementation 10 is conducted pursuant to well-known procedures associated with generating, testing and installing code as with COOL:GEN™ software. However, a few key aspects of implementation 10 are highlighted below.

One step in implementation 10 is the actual creation of a database. To alleviate previously encountered problems each component 18 “owns” its own data. The data is never accessed directly from another component. Instead, data is shared between components via the services offered by a component.

Whenever possible, it is desirable that all components 18 share a single database. The use of a single database significantly reduces the amount of work and complexity involved should a database ever have to be recovered to a point in time.

Another step in implementation 10 is the generation of component services. The service must be published (e.g. made available for consumption by the applications 12) and installed (e.g. to a mainframe or server, etc.). It should be noted that transient views should be used to isolate the physical database structures from the consuming application 12 (e.g. that the services expose only transient views) such that the database(s) can be changed without affecting the consuming application 12. Further, if applicable, legacy systems should be accessed via external action blocks.

Facets 14 should be generated and installed. Facet 14 installation is generally site specific. Most sites will have an automated software distribution facility (e.g. SMS from Microsoft®). Similarly, hubs 16 are generated and installed.

As indicated at block 94, the application 12 should be tested prior to use. For workstation testing, a test harness must be created to test each individual service. A test harness is a skeleton application that merely provides a mechanism to feed a service its required inputs and to display its outputs. It allows developers to take advantage of the trace facilities provided within COOL:GEN™ to verify that the logic is working as specified.

Finally, a delivery phase is conducted. In the delivery phase, the application and supporting component services are installed at the project level. It is at this point in the overall project that each of the application slices are merged back into the total project for integration, testing and implementation.

VIII. Incremental Component Development

The method of the present invention incrementally develops software products. The method uses two techniques to help reach this goal.

Beginning in the Initiation phase, a project may be broken into multiple software releases. A software release must contain sufficient scope to provide a complete set of functionality to the business when implemented. This functionality might be stand-alone or may add new features to existing systems. In general, a software release should be smaller rather than larger in size. The goal is to develop the smallest reasonable set of software in each release so as to quickly deliver benefit without sacrificing completeness or integrity.

From a project management standpoint, this provides several benefits:

1. The first software release acts as a pilot project for the following releases. Many of the issues which must be resolved in each phase are found early on and can be addressed before the entire project is delayed.

2. The project team gains the benefit of having gone through the entire development life cycle with a smaller, more manageable, set of deliverables. This gives them the experience to improve development skills and practices on each subsequent release.

3. The project team builds credibility with the business by quickly delivering useful functionality. They also receive feedback that can be applied to standards, facet layouts, etc to improve later deliverables.

4. The project team is better able to respond to changes in requirements since the times between software releases are relatively short in duration. Priorities can be re-evaluated after each release to make sure that the proper business solutions are being delivered.

Application Slices

The goal with software releases is to break a project into smaller, more manageable, implementations which can provide early and steady delivery of useful functionality. The primary purpose of application slices is to level resource requirements during the development of a software release.

By breaking a software release into application slices, parts of the application which are simpler or more completely understood can move into specification and design, while other sections that require further analysis can remain in the visualization phase.

This provides two benefits to project managers:

1. Resources which are required in later phases are put to work earlier in the project. This means that fewer specification and design resources may be required overall—as phase tasks complete on one application slice, the next slice is ready to enter that phase.

2. The earlier application slices also serve as pilot projects within the software release. The first slice in particular is a test case for new environment parameters, standards, etc. once any problems which have been highlighted by the first application slice are solved, the remainder of the slices have a much better chanced of avoiding being delayed by the same issues.

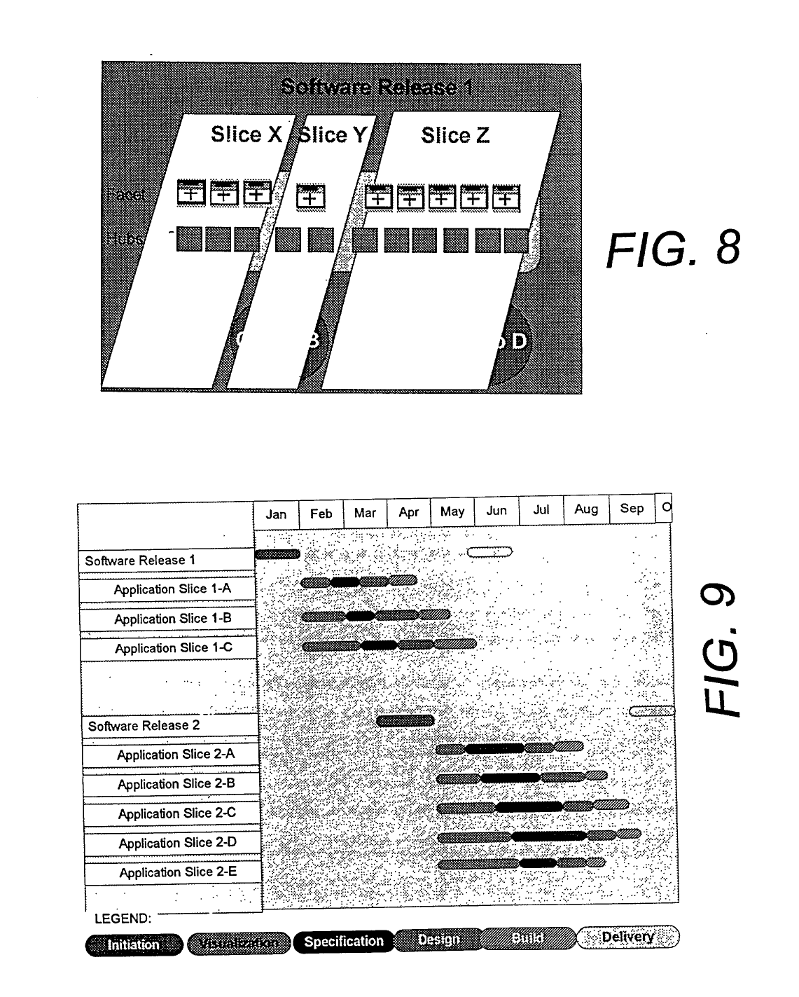

FIG. 8 shows how the various deliverables might be organized into application slices within a software release.

Staggered development and delivery example.

FIG. 9 illustrates how a typical project can be developed and delivered in increments. The example shown in FIG. 9 contains two software releases, each divided into application slices.

IX. Model Management Guidelines

The objective of developing a strategy for managing component models is to provide a single location from which components can be distributed to consuming applications, and which can be used for change-impact analysis and version control.

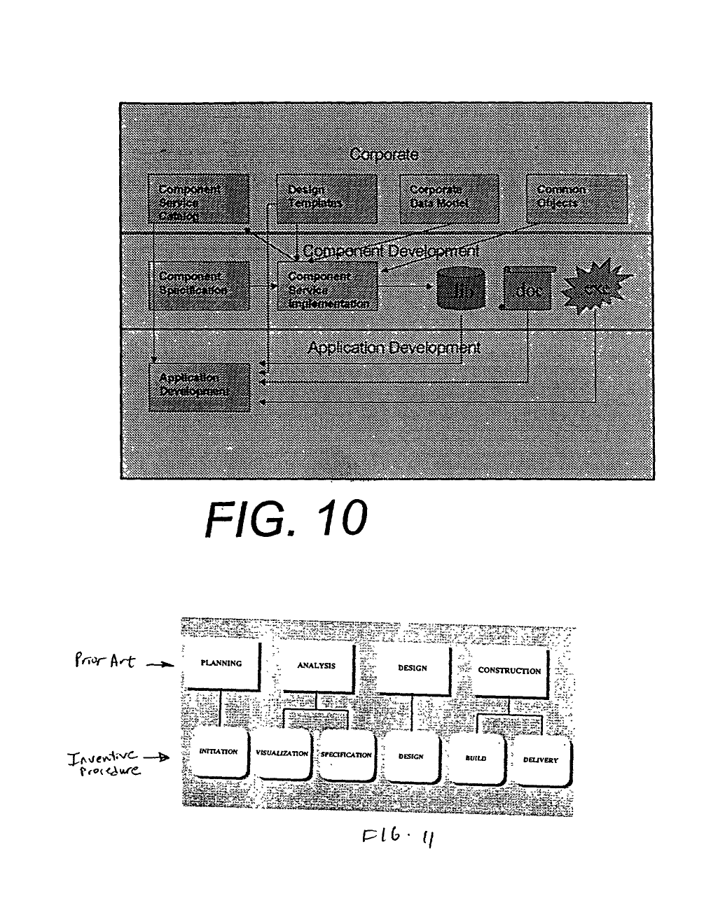

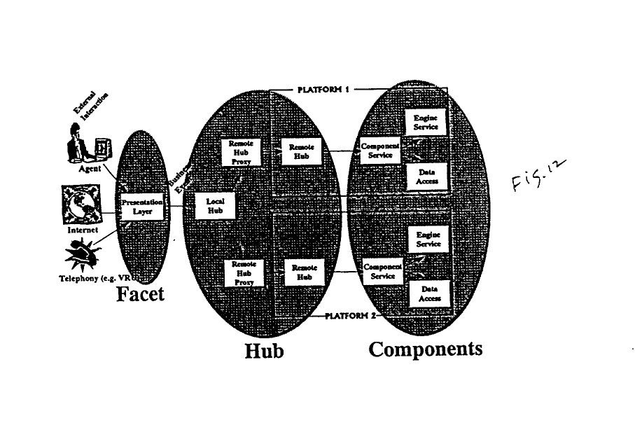

By way of example, the emphasis made here will be on the types of models that are supported by an appropriate component model management strategy, not on the particular techniques used by development teams and model managers in deriving models. As an example, component developers might derive a component specification model from their completed component implementation model (by using model-copy and removing implementation-related objects), or they might derive the component specification model from an analysis of the data and services that might be supported (before implementation work has even begun). Using either technique, a valid components specification model can be built for use by consuming applications. Progression models are shown in FIG. 10.

Component Catalog Model

At the corporate organizational level, a component catalog model should be established on an encyclopedia. In organizations that use multiple encyclopedia, one encyclopedia should be named as steward for this catalog model. In the multiple-encyclopedia environment, copies of the component catalog model should contain the specification elements of all published components. The component catalog is the source for components used by applications and other components.

Component Specification Model

Component specifications are derived in Components Specification models, which are built in part from data definitions already owned by the organization—in perhaps a corporate data model or a collection of COBOL copybooks. Public services are defined for the component. Completed specifications are migrated from the component specification models to the component catalog model as part of the publication process.

Component Implementation Model

Component implementations are performed in Component Implementation models, which are created by copying component specification models. The component implementation models contain internal services, the model of persistent data types and the implementation of the persistent storage (where applicable). From the component specification and component implementation models come the component's specification, object library, documentation, executables and test harness.

Application Development Model

Application development models are used to build the applications (facets and hubs) which consume the component services. These models contain all of the facet and hub logic as well as the class diagram and service interface modules for nay component/service the application is consuming.

X. Managing Component Models in COOL:GEN™

The following steps describe a process for managing component models.

1. Creation of component specification model

The component specification model is created. Classes, public services, service-results work set, and packaging elements are created.

2. Migration of completed component specification model to component catalog

After the component specification model is complete, its classes, public services, service-result work set, and packaging are migrated to the component catalog. In twin-track development environments, where applications and the consumed components are being built in tandem, a series of migrations might be employed. As services are specified, they can be migrated to the component catalog for use by applications. Finally, at the close of work on the components specification model, all specification elements for the component will have been migrated to the component catalog.

3. Migration from component catalog to application development model

Application development teams must have component specifications migrated from the component catalog to their development model or models in order to invoke a component's services. One technique is to migrate the component specification elements to a “temporary” model and delete from this model any services not requested or needed by the application model. Since scoped data model art objects require that all public services accompany it when migrated, the “temporary” model gives the opportunity to remove services before migrating to the application model.

It is in this “temporary” model that the public services are changed to externals. Migration to the destination application model uses the “temporary” model as the source of the migration.

4. Communication of change requests

Application development teams request changes to services and make requests for new services by communicating with the component provisioners. Changes are recognized (perhaps via a new version of a component) by repeating the migration cycle from component development catalog to consuming application.

It is understood that while certain forms of the present invention have been illustrated and described herein, it is not to be limited to the specific forms or arrangements of parts described and shown.

It is to be understood that while certain forms of the present invention have been illustrated and described herein, it is not to be limited to the specific forms or arrangement of parts described and shown.

What is claimed and desired to be secured by Letters Patent is as follows:

1. A method of component-based systems development for producing a computer software application for storing data and accessing, processing, and outputting the data comprising:
a. identifying and modeling one or more business processes with one or more steps to each said business process; and identifying business data relating to each step;
b. designing and creating one or more independent set of software services with each said service corresponding to a respective business process;
c. designing and creating at least one database for storing the business data; said database being shared by said software services;
d. using one or more computer software applications to access and process the data through the components; and
e. using an interactive electronic terminal to allow a user to access and operate the software applications and access the business data.

2. A method of component-based systems development for producing a computer software application for storing data and accessing, processing, and outputting the data, comprising:
a. initiation;
b. visualization;
specification;
d. design; and
e. implementation.

3. The method defined in claim 2 wherein said implementation step includes building and delivering an application.

4. A method of providing data and information comprising:
a. providing an application by:
providing a facet,
providing a hub, and
accessing the hub from the facet; and
providing a component by producing computer software for storing data and accessing, processing, and outputting the data which comprises steps of identifying and modeling one or more business processes with one or more steps to each said business process; and identifying business data relating to each step,
designing and creating one or more independent set of software services with each said service corresponding to a respective business process, and designing and creating at least one database for storing the business data; said database being shared by said software services.

5. The method defined in claim 4 further including a step of providing a plurality of components.

6. The method defined in claim 5 further including a step of providing communication between the hub and each of the plurality of components.

7. The method defined in claim 6 further including a step of providing a plurality of hubs.

8. The method defined in claim 7 further including a step of providing communication between each hub and each component.

9. The method defined in claim 1 wherein the step of identifying business data further includes a step of using legacy systems.

10. The method defined in claim 9 wherein the step of using legacy systems further includes a step of modularizing each legacy system.

11. A method of performing computer-based system development using only data from a known project.

12. The method defined in claim 11 further including a step of visualization which includes a step of developing application slices.

13. The method defined in claim 12 further including a step of identifying legacy systems.

14. The method defined in claim 13 further including a step of specification.

15. The method defined in claim 14 further including a step of design which includes modularizing legacy systems.

16. The method defined in claim 15 further including a step of insulating legacy systems.

17. The method defined in claim 16 further including a step of implementation.

18. The method defined in claim 17 further including a step of providing a facet.

19. The method defined in claim 18 further including a step of providing a hub communicating with the facet.

20. The method defined in claim 19 further including a step of providing a component communicating with the hub.

21. The method defined in claim 20 further including a step of providing a plurality of components and further including a step of establishing communication between each of the components and the hub.

22. The method defined in claim 21 further including a step of providing a plurality of components and further including a step of establishing communication between each of the components and one or more hubs.

23. The method defined in claim 22 further including a step of providing each component with one or more services.

24. The method defined in claim 23 further including a step of having each service represent an end result.

25. The method defined in claim 22 further including a step of separating some components from other components.

26. The method defined in claim 12 further including a step of defining each application slice to contain a single component.

27. The method defined in claim 15 further including a step of insulating modularized systems.

28. The method defined in claim 17 wherein the step of insulating the modularized systems further includes a step of providing a wrapper to encapsulate each modularized system.

29. The method defined in claim 28 further including a step of accessing modularized legacy systems via external action blocks.

30. A method of component-based systems development comprising:
providing a plurality of facets;
providing a plurality of hubs;
establishing communication between each hub and one of the plurality of facts;
providing a plurality of components;
establishing communication between each component and each hub; and
producing computer software for storing data and accessing, processing and outputting data by producing a computer software application for storing data and accessing, processing and outputting data and which comprises the steps of:
identifying and modeling one or more business processes with one or more steps to each said business process and identifying business data relating to each step,
designing and creating one or more independent set of software services with each said service corresponding to a respective business process, and
designing and creating at least one database for storing the business data; said database being shared by said software services.

31. The method defined in claim 30 further including a step of wherein the step of producing computer software includes using only data from a known project.

32. The method defined in claim 31 further including a step of providing each component with a plurality of services.

33. The method defined in claim 32 wherein the step of identifying business data further includes a step of using legacy systems.

34. The method defined in claim 33 wherein the step of using legacy systems further includes a step of modularizing each legacy system.

35. The method defined in claim 34 further including a step of visualization which includes a step of developing application slices.

36. The method defined in claim 35 further including a step of modularizing legacy systems.

37. The method defined in claim 36 further including a step of insulating legacy systems.

38. The method defined in claim 2 further including a step of developing a class diagram.

39. The method defined in claim 38 further including a step of freezing the class diagram during specification.

40. The method defined in claim 39 further including a step of developing detailed requirements for an application during specification.

41. The method defined in claim 14 further including a specification step.

42. The method defined in claim 41 further including defining a slice during specification.

38. The method defined in claim 30 wherein the step of producing computer software includes using only data from a known project.
